(19) United States
(12) Patent Application Publication
(10) Pub. No.: US 2022/0376592 A1
(43) Pub. Date: Nov. 24, 2022

(54) AXIAL FLUX MOTOR DRIVE UNIT WITH TWO INDEPENDENT ROTORS SHARING A STATOR

(71) Applicant: GM Global Technology Operations LLC, Detroit, MI (US)

(72) Inventors: Chengwu Duan, Shanghai (CN); Alan G. Holmes, Clarkston, MI (US); Jian Yao, Shanghai (CN)

(21) Appl. No.: 17/324,918

(22) Filed: May 19, 2021

(51) Int. Cl. H02K 16/02; H02K 7/00; H02K 7/116; H02K 1/18

(52) U.S. Cl. CPC H02K 16/02; H02K 7/006; H02K 7/116; H02K 1/182

(57) ABSTRACT

An axial flux motor drive unit for an automobile includes a stator defining a core, an output defining an axis of rotation, a first rotor, a second rotor, and a thrust bearing. The first rotor is rotatable about the axis of rotation and is coupled to the output and disposed relative to the stator to create a first air gap. The second rotor is rotatable about the axis of rotation and is coupled to the output and is disposed relative to the stator to create a second air gap. The thrust bearing is coupled to the output and supports axial loads that are substantially parallel to the axis of rotation, and the first rotor is still rotatable about the axis of rotation when the second rotor is inoperable, and the second rotor is still rotatable when the first rotor is inoperable.

### INTRODUCTION

The present disclosure relates to an axial flux motor drive unit for an automobile. More particularly, the present disclosure relates to an axial flux motor drive unit having two independent rotors sharing a stator, where each rotor is operable independent of the remaining rotor.

Electric motors are increasingly being used to power vehicles, such as automobiles. It is to be appreciated that electric propulsion offers opportunities to increase automobile performance and control of vehicle dynamics, both by operating wheels individually and by adding aerodynamic forces to improve or to assist wheel traction. Specifically, in order to increase vehicle efficiency and dynamics, an electric motor is designed to be as compact as possible and have a relatively low weight. Axial flux motors, which offer excellent torque and power densities especially for short length applications, may be particularly suitable for powering a vehicle. Specifically, axial flux motors produce flux that runs parallel to the axis of the output shaft, and therefore are referred to as axial. In contrast, radial flux motors produce flux radially with respect to the output shaft, and therefore are referred to as radial. The resulting packaging space required for an axial flux motor is disc-shaped. The disc-shaped packaging space includes a relatively short and compact profile, thereby making axial flux motors potential candidates for use in cramped quarters. In addition to vehicles, axial flux motors may be used in other applications as well, such as aerial vehicles.

Thus, while axial flux motors achieve their intended purpose, there is a need in the art for an axial motor with improved reliability that provides high efficiency.

### SUMMARY

According to several aspects, an axial flux motor drive unit for an automobile is disclosed. The axial flux motor drive unit includes a stator defining a core, an output defining an axis of rotation, a first rotor, a second rotor, and a thrust bearing. The first rotor is rotatable about the axis of rotation and is coupled to the output. The first rotor is disposed relative to the stator to create a first air gap between the stator and the first rotor. The second rotor is rotatable about the axis of rotation and coupled to the output. The second rotor is disposed relative to the stator to create a second air gap between the stator and the second rotor. The thrust bearing is coupled to the output for supporting axial loads that are substantially parallel to the axis of rotation, where the first rotor is still rotatable about the axis of rotation when the second rotor is inoperable, and where the second rotor is still rotatable when the first rotor is inoperable.

In another aspect, the stator further includes a first plurality of windings that are wound around a first portion of the core.

In yet another aspect, a first magnetic flux is generated within the first air gap in response to the first plurality of windings being supplied with alternating current (AC) power.

In still another aspect, the axial flux drive motor unit further comprises a first invertor that supplies AC power to the first plurality of windings.

In another aspect, the stator further includes a second plurality of windings that are wound around a second portion of the core.

In yet another aspect, a second magnetic flux is generated within the second air gap in response to the second plurality of windings being supplied with AC power.

In still another aspect, a second invertor that supplies AC power to the second plurality of windings.

In another aspect, the axial flux drive motor unit further comprises a first planetary gearset coupled to a first end of the output, where the first planetary gearset includes a first sun gear, a first plurality of carriers, and a first ring gear.

In yet another aspect, the first sun gear is a helical gear including a plurality of teeth oriented at a first selected helix angle.

In still another aspect, the axial flux drive motor unit further comprises a second planetary gearset coupled to a second end of the output, where the second planetary gearset includes a second sun gear, a second plurality of carriers, and a second ring gear.

In another aspect, the second sun gear is a helical gear including a plurality of teeth oriented at a second selected helix angle.

In an aspect, a first output of the first planetary gearset rotates in a first direction and a second output of the second planetary gearset rotates in a second direction that is opposite to the first direction.

In yet another aspect, the axial flux drive motor unit further comprises a one-way clutch coupled to both the first rotor and the second rotor.

In one aspect, an axial flux motor drive unit for an automobile is disclosed. The axial flux motor drive unit includes a stator defining a core. The stator includes a first plurality of windings that are wound around a first portion of the core and a second plurality of windings that are wound around a second portion of the core. The axial flux drive motor unit also includes a first invertor supplying AC power to the first plurality of windings and a second invertor suppling AC power to the second plurality of windings. The axial flux motor drive unit also includes an output defining an axis of rotation and a first rotor rotatable about the axis of rotation and coupled to the output. The first rotor is disposed relative to the stator to create a first air gap between the stator and the first rotor, where a first magnetic flux is generated within the first air gap in response to the first plurality of windings being supplied with AC power. The axial flux drive motor unit also includes a second rotor rotatable about the axis of rotation and coupled to the output. The second rotor is disposed relative to the stator to create a second air gap between the stator and the second rotor, where a second magnetic flux is generated within second first air gap in response to the second plurality of windings being supplied with AC power. The axial flux motor drive unit also includes a thrust bearing coupled to the output for supporting axial loads that are substantially parallel to the axis of rotation, where the first rotor is still rotatable about the axis of rotation when the second rotor is inoperable, and where the second rotor is still rotatable when the first rotor is inoperable.

In one aspect, the axial flux drive motor unit further comprises a first planetary gearset coupled to a first end of the output, where the first planetary gearset includes a first sun gear, a first plurality of carriers, and a first ring gear.

In yet another aspect, the first sun gear is a helical gear including a plurality of teeth oriented at a first selected helix angle.

In still another aspect, the axial flux drive motor unit further comprises a second planetary gearset coupled to a second end of the output, where the second planetary gearset includes a second sun gear, a second plurality of carriers, and a second ring gear.

In another aspect, the second sun gear is a helical gear including a plurality of teeth oriented at a second selected helix angle.

In yet another aspect, a first output of the first planetary gearset rotates in a first direction and a second output of the second planetary gearset rotates in a second direction that is opposite to the first direction.

In another aspect, the axial flux drive motor unit further comprises a one-way clutch coupled to both the first rotor and the second rotor.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of one embodiment of the disclosed axial flux motor drive unit for an automobile according to an exemplary embodiment;

FIG. 2 is a schematic illustration of the axial flux drive unit including two planetary gearsets according to an exemplary embodiment;

FIG. 3 is an illustration of a sun gear that is part of one of the planetary gearsets shown in FIG. 1 according to an exemplary embodiment;

FIG. 4 is an alternative embodiment of the axial flux motor drive unit including a one-way clutch assembly according to an exemplary embodiment; and

FIG. 5 is an alternative embodiment of the axial flux drive motor according to an exemplary embodiment.

### DETAILED DESCRIPTION

The following description is merely exemplary in nature and is not intended to limit the present disclosure, application, or uses.

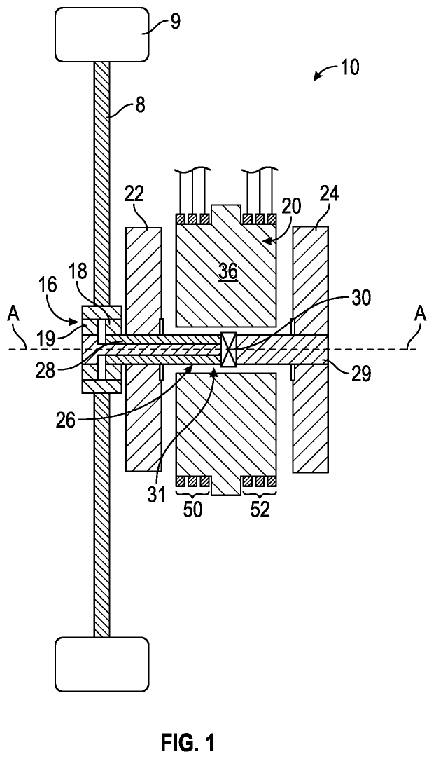

Referring to FIG. 1, a schematic cross-sectioned view of an axial flux motor drive unit 10 for an automobile including a wheel 8 and tire assembly 9 is illustrated. The disclosed axial flux motor drive unit 10 includes a single stator 20, two rotors 22, 24, an output 26 defining an axis of rotation A-A of the axial flux motor drive unit 10, and a thrust bearing 30. Specifically, the axial flux motor drive unit 10 includes a first rotor 22 and a second rotor 24. In the embodiment as shown in FIG. 1, the output 26 comprises a first shaft 28 coupled to a second shaft 29 by the thrust bearing 30. Accordingly, the thrust bearing 30 is coupled to the output 26, and allows for each rotor 22, 24 to operate independently from one another. Accordingly, if one of the rotors 22, 24 become inoperable, then the remaining rotor 22, 24 is still able to operate. In one embodiment, the axial flux motor drive unit 10 is employed in an automobile, however, it is to be appreciated that the axial flux motor drive unit 10 may be used in other applications as well.

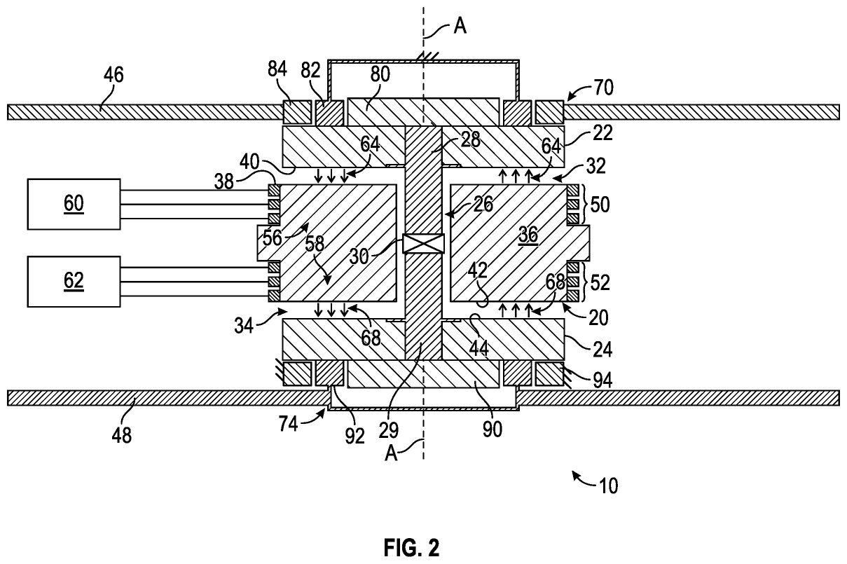

In the embodiment as shown in FIG. 1, the output 26 of the axial flux motor drive unit 10 is connected to a single output by a one-way clutch assembly 16. Specifically, the single output, which is the wheel 8, is connected to the output 26 by a one-way clutch assembly 16. The one-way clutch assembly 16 includes a first selectable one-way clutch 18 coupled to the first rotor 22 by the first shaft 28 and a second selectable one-way clutch 19 coupled to the second rotor 24 by the second shaft 29. In the embodiment as shown in FIG. 1, the first shaft 28 is a sleeve shaft and the second shaft 29 is a stepped shaft, and the thrust bearing 30 is disposed at a step 31 defined by the second shaft 29. Referring now to FIG. 2, in another embodiment the output 26 of the axial flux motor drive unit 10 is connected to two separate outputs. Specifically, the axial flux motor drive unit 10 is connected to a first output 46 and a second output 48. In the embodiment as shown in FIG. 2, the axial flux motor drive unit 10 may be employed in an aerial vehicle, where the first output 46 and the second output 48 represent a top and bottom blade of the aerial vehicle. In the embodiment as shown in FIG. 2, both the first shaft 28 and the second shaft 29 are both solid shafts coupled to one another by the thrust bearing 30.

Continuing to refer to FIG. 2, the stator 20 defines a core 36. The first rotor 22 is rotatable about the axis of rotation A-A. The first rotor 22 is coupled to the output 26 and disposed relative to the stator 20 to create a first air gap 32 between the stator 20 and the first rotor 22. In the embodiment as shown, the first air gap 32 is disposed between an upper surface 38 of the core 36 of the stator 20 and a lower surface 40 of the first rotor 22. A second rotor 24 is rotatable about the axis of rotation A-A and is coupled to the output 26. The second rotor 24 is disposed relative to the stator 20 to create a second air gap 34 between the stator 20 and the second rotor 24. In the embodiment as shown, the second air gap 34 is disposed between a lower surface 42 of the core 36 of the stator 20 and an upper surface 44 of the first rotor 22.

Continuing to refer to FIG. 2, the thrust bearing 30 is coupled to the output 26 and supports axial loads substantially parallel to the axis of rotation A-A. The thrust bearing 30 allows for each rotor 22, 24 to operate independently from one another. Accordingly, the first rotor 22 is still rotatable about the axis of rotation A-A when the second rotor 24 is inoperable, and the second rotor 24 is still rotatable when the first rotor 22 is inoperable.

The axial flux motor drive unit 10 further includes a first plurality of windings 50, a second plurality of windings 52, a first invertor 60, and a second invertor 62. The first plurality of windings 50 are wound around a first portion 56 of the core 36 of the stator 20, and the second plurality of windings 52 are wound around a second portion 58 of the stator 20. The first invertor 60 is electrically coupled to and provides alternating current (AC) power to the first plurality of windings 50. As seen in FIG. 2, a first magnetic flux 64 is generated within the first air gap 32 in response to the first plurality of windings 50 being supplied with AC power. Similarly, the second invertor 62 is electrically coupled to and provides AC power to the second plurality of windings 52. As seen in FIG. 2, a second magnetic flux 68 is generated within the second air gap 34 in response to the second plurality of windings 52 being supplied with AC power.

The first plurality of windings 50 and the first invertor 60 are electrically separate from the second plurality of windings 52 and the second invertor 62. That is, the stator windings 50, 52 are split into two electrically separate systems that are powered by two separate invertors 60, 62. Accordingly, if the first plurality of windings 50 or the first invertor 60 are non-operational, the second rotor 24 may still operate. Similarly, if the second plurality of windings 52 or the second invertor 62 are non-operational, then the first rotor 22 may still operate.

In the embodiment as shown in FIG. 2, the axial flux motor drive unit 10 includes a first planetary gearset 70 coupled to the first shaft 28 of the output 26 and a second planetary gearset 74 coupled to the second shaft 29 of the output 26. The first planetary gearset 70 includes a first sun gear 80, a first plurality of carriers 82, and a first ring gear 84. Similarly, the second planetary gearset 74 includes a second sun gear 90, a second plurality of carriers 92, and a second ring gear 94. The first planetary gearset 70 is connected to the first output 46, and the second planetary gearset 74 is connected to the second output 48.

In the non-limiting embodiment as shown, the plurality of carriers 82 are fixed, and the first output 46 is connected to the first ring gear 84, and the second ring gear 94 is fixed and the second plurality of carriers 92 are connected to the second output 48. Thus, the planetary gearsets 70, 74 allow for the first output 46 of the first planetary gearset 70 to rotate in a first direction and the second output 48 of the second planetary gearset 74 to rotate in a second direction that is opposite to the first direction. Although FIG. 2 illustrates the plurality of carriers 82 as fixed, the first output 46 connected to the first ring gear 84, the second ring gear 94 as fixed, and the second plurality of carriers 92 connected to the second output 48, it is to be appreciated that FIG. 2 is merely exemplary in nature, and other connections may be used as well to allow for the rotors 22, 24 to rotate in opposing directions.

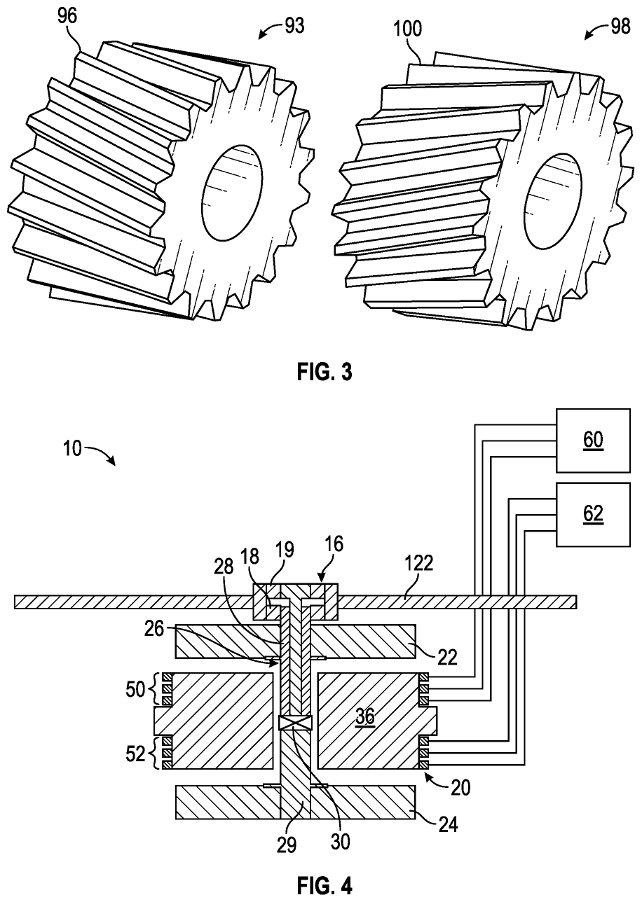

Referring to FIG. 3, in one embodiment the first sun gear 80 is a helical gear 93 including a plurality of teeth 96 oriented at a first selected helix angle β₁. The first selected helix angle β₁ is selected to generate an axial force that offsets a magnetic force between the first rotor 22 and the stator 20 in an axial direction that is substantially parallel to the axis of rotation A-A (seen in FIG. 1). Specifically, a direction as well as a value or magnitude of the first selected helix angle β₁ is selected to generate the axial force. In one embodiment, the magnitude of the first selected helix angle β₁ is selected to counteract the magnetic force between the first rotor 22 and the stator 20 during operating conditions that occur the most frequently such as, for example, when the automobile or the aerial vehicle operates at cruising speeds.

In an embodiment, the second sun gear 90 is a helical gear 98 and includes the plurality of teeth 100 oriented at a second selected helix angle β₂, where the second selected helix angle β₂ is selected to generate an axial force that offsets a magnetic force between the second rotor 24 and the stator 20.

FIG. 4 illustrates the one-way clutch assembly 16 coupled to both the first rotor 22 and the second rotor 24. Specifically, the one-way clutch assembly 16 includes the first selectable one-way clutch 18 coupled to the first rotor 22 and the second selectable one-way clutch 19 coupled to the second rotor 24. As seen in FIG. 3, a single output 122 is connected to the one-way clutch assembly 16. In the event one of the rotors 22, 24 become non-operational, the remaining rotor 22, 24 overruns the one-way clutch assembly 16. Accordingly, the single output 122 may still rotate even if one of the rotors 22, 24 do not operate.

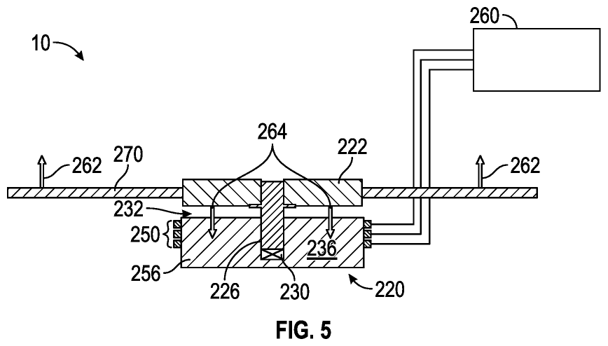

FIG. 5 illustrates another embodiment of the axial flux motor drive unit 10 employed in an aerial vehicle. In the embodiment as shown in FIG. 5, the axial flux motor drive unit 10 includes a single stator 220, a single rotor 222, an output 226, and a thrust bearing 230. As seen in FIG. 5, a plurality of windings 250 are wound around a portion 256 of a core 236 of the stator 20, where an invertor 260 is electrically coupled to and provides AC power to the plurality of windings 250. The single rotor 222 is disposed relative to the stator 220 to create an air gap 232 between the stator 220 and the single rotor 222. It is to be appreciated that since the axial flux motor drive unit 10 shown in FIG. 5 includes fewer components than the embodiments as shown in FIGS. 1, 2, and 4, the approach shown in FIG. 5 provides a low-cost solution.

As seen in FIG. 5, a blade 270 is coupled directly to the single rotor 222, where the blade 270 rotates in concert with the single rotor 222. The blade 270 generates lift, which is shown as an aerodynamic force 262 that is oriented in an upward direction. The aerodynamic force 262 generated by the blade 270 counteracts a magnetic force 264 that is oriented in an opposite or downward direction. The magnetic force 264 is created in response to the plurality of windings 250 being supplied with AC power by the invertor 260. It is to be appreciated that the aerodynamic force 262 may cancel the magnetic force 264, which is a function the area and length of the air gap 232. Reducing or eliminating the magnetic force 264 may result in reducing or eliminating bearing loss and wear of the thrust bearing 230. In an embodiment, gears (not shown) may be used between the single rotor 22 and the blade 270 to balance the aerodynamic force 262 and the magnetic force 264.

Referring generally to the figures, the disclosed axial flux motor drive unit includes various technical effects and benefits. Specifically, the axial flux motor drive unit has a relatively short and compact profile and includes two rotors that operate independently of one another. Thus, if one of the rotors are non-operational, the other rotor is still able to operate. The axial flux motor drive unit also includes electrically separate windings and invertors as well, which also allow one of the rotors to operate in the event of a short-circuit or open-circuit condition with one of the invertors or windings. Finally, if the axial flux drive unit includes one or more planetary gearsets, the sun gear may include a selected helix angle that support some or all of the thrust loads that occur during operation, which in turns improves reliability.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An axial flux motor drive unit for an automobile, the axial flux motor drive unit comprising:
a stator defining a core;
an output defining an axis of rotation;
a first rotor rotatable about the axis of rotation and coupled to the output and disposed relative to the stator to create a first air gap between the stator and the first rotor;
a second rotor rotatable about the axis of rotation and coupled to the output and disposed relative to the stator to create a second air gap between the stator and the second rotor; and
a thrust bearing coupled to the output for supporting axial loads that are substantially parallel to the axis of rotation, wherein the first rotor is still rotatable about the axis of rotation when the second rotor is inoperable, and wherein the second rotor is still rotatable when the first rotor is inoperable.

2. The axial flux motor drive unit of claim 1, wherein the stator further includes a first plurality of windings that are wound around a first portion of the core.

3. The axial flux motor drive unit of claim 2, wherein a first magnetic flux is generated within the first air gap in response to the first plurality of windings being supplied with alternating current (AC) power.

4. The axial flux motor drive unit of claim 3, further comprising a first invertor that supplies AC power to the first plurality of windings.

5. The axial flux motor drive unit of claim 1, wherein the stator further includes a second plurality of windings that are wound around a second portion of the core.

6. The axial flux motor drive unit of claim 5, wherein a second magnetic flux is generated within the second air gap in response to the second plurality of windings being supplied with alternating current (AC) power.

7. The axial flux motor drive unit of claim 6, further comprising a second invertor that supplies AC power to the second plurality of windings.

8. The axial flux motor drive unit of claim 1, further comprising a first planetary gearset coupled to a first end of the output, wherein the first planetary gearset includes a first sun gear, a first plurality of carriers, and a first ring gear.

9. The axial flux motor drive unit of claim 8, wherein the first sun gear is a helical gear including a plurality of teeth oriented at a first selected helix angle.

10. The axial flux motor drive unit of claim 8, further comprising a second planetary gearset coupled to a second end of the output, wherein the second planetary gearset includes a second sun gear, a second plurality of carriers, and a second ring gear.

11. The axial flux motor drive unit of claim 10, wherein the second sun gear is a helical gear including a plurality of teeth oriented at a second selected helix angle.

12. The axial flux motor drive unit of claim 10, wherein a first output of the first planetary gearset rotates in a first direction and a second output of the second planetary gearset rotates in a second direction that is opposite to the first direction.

13. The axial flux motor drive unit of claim 1, further comprising a one-way clutch coupled to both the first rotor and the second rotor.

14. An axial flux motor drive unit for an automobile, the axial flux motor drive unit comprising:
a stator defining a core, the stator including a first plurality of windings that are wound around a first portion of the core and a second plurality of windings that are wound around a second portion of the core;
a first invertor supplying AC power to the first plurality of windings and a second invertor suppling AC power to the second plurality of windings;
an output defining an axis of rotation;
a first rotor rotatable about the axis of rotation and coupled to the output and disposed relative to the stator to create a first air gap between the stator and the first rotor, wherein a first magnetic flux is generated within the first air gap in response to the first plurality of windings being supplied with AC power;
a second rotor rotatable about the axis of rotation and coupled to the output and disposed relative to the stator to create a second air gap between the stator and the second rotor, wherein a second magnetic flux is generated within second first air gap in response to the second plurality of windings being supplied with AC power; and
a thrust bearing coupled to the output for supporting axial loads that are substantially parallel to the axis of rotation, wherein the first rotor is still rotatable about the axis of rotation when the second rotor is inoperable, and wherein the second rotor is still rotatable when the first rotor is inoperable.

15. The axial flux motor drive unit of claim 14, further comprising a first planetary gearset coupled to a first end of the output, wherein the first planetary gearset includes a first sun gear, a first plurality of carriers, and a first ring gear.

16. The axial flux motor drive unit of claim 15, wherein the first sun gear is a helical gear including a plurality of teeth oriented at a first selected helix angle.

17. The axial flux motor drive unit of claim 15, further comprising a second planetary gearset coupled to a second end of the output, wherein the second planetary gearset includes a second sun gear, a second plurality of carriers, and a second ring gear.

18. The axial flux motor drive unit of claim 17, wherein the second sun gear is a helical gear including a plurality of teeth oriented at a second selected helix angle.

19. The axial flux motor drive unit of claim 17, wherein a first output of the first planetary gearset rotates in a first direction and a second output of the second planetary gearset rotates in a second direction that is opposite to the first direction.

20. The axial flux motor drive unit of claim 14, further comprising a one-way clutch coupled to both the first rotor and the second rotor.
